(19) United States
(12) Patent Application Publication
(10) Pub. No.: US 2018/0127190 A1
(43) Pub. Date: May 10, 2018

(54) FOOD PACKAGING CONTAINER, PACKAGING METHOD AND APPLICATION THEREOF

(71) Applicant: Kui KANG, Beijing (CN)

(72) Inventor: Kui KANG, Beijing (CN)

(21) Appl. No.: 15/861,644

(22) Filed: Jan. 3, 2018

Related U.S. Application Data
(63) Continuation of application No. PCT/CN2016/091530, filed on Jul. 25, 2016.

(30) Foreign Application Priority Data
Jul. 27, 2015 (CN) 201510446767.1

(51) Int. Cl. B65D 81/34; B32B 27/00; B65D 65/22; B65D 85/72

(52) U.S. Cl. CPC B65D 81/3461; B65D 85/72; B65D 65/22; B32B 27/00

(57) ABSTRACT

The present disclosure discloses a food packaging container and a packaging method and an application thereof. The packaging container 1 is applied for food storing and microwave heating. The packaging container 1 includes a container main body 2, an outlet part 3 connected to the container main body 2, and a protecting cap 5 sheathed on the outlet 3. An opening is provided on the outlet part and a sealing film 4 is provided on the opening. The packaging container is rational and simple in structure, which can be heated directly in the microwave. The food would not block an air vent and the food is ready to serve after microwave heating, exhibiting an excellent practical application value.

### TECHNICAL FIELD

The present disclosure relates to a field of packaging container, and specifically to a food packaging container, a packaging method and an application thereof.

### BACKGROUND

Recently, microwave heating of food has been increasingly popularized due to its convenience and hygiene. However, if food is packed or placed in a package and then placed in the microwave, a large amount of water steam will accumulate in the package, and it is possible to burst without opening the package.

Food package usually has to be opened before microwave heating or holes have to be manually made to penetrate the package, so as to make sure an appropriate cooking, to release the water steam during the microwave heating and prevent a bursting of the package. Further, food has to be served in the plate or bowl after its microwave heating in the package, and a direct serving is not able to be achieved. Other packages with air venting holes and plugging material do not ensure a consistent validation of the package sealing, since the plugging material is vulnerable to temperatures and moisture contents in extreme natural environments. A location of the designed air venting hole is not scientific nor a configuration is not rational. The air venting holes are easily to be blocked by food inside during microwave heating so that air venting can not be achieved.

### SUMMARY

Aiming to the existed technical problems, the present disclosure is to provide a food packaging container for storing and microwave heating, a packaging method and an application thereof, to prevent the previously mentioned technical deficiencies. One of the objectives of the present disclosure is to provide a food packaging container for food storing and microwave heating. The food packaging container includes a container main body, an outlet part connected through to the container main body, and a protecting cap sheathed on the outlet part, wherein an opening is provided on top of the outlet part, and a sealing film is provided on the opening.

Further, the container main body is screwed with the protecting cap, and a globoidal bulge is provided on top of the protecting cap.

Further, a plurality of first air vents are provided on the sealing film.

Further, a plurality of second air vents are provided coordinated with the first air vent on the protecting cap.

Further, a diameter of a connecting section is in a range of 3-20 cm between the container main body and the opening.

Further, a diameter of an opening end of the outlet part is in a range of 0.7-10 cm, and a diameter is in a range of 0.5-6 cm of the an end where the second air vent is provided.

Further, a diameter of the first air vent is in a range of 0.5-2.0 mm, and a diameter of the second air vents is in a range of 1.0-3.0 mm.

Further, a number of the first air vent is 3-5, a number of the second air vents is 3, and the second air vents are provided in a concave at 3-5 mm inside the top of the protecting cap.

Further, the sealing film has four layers. The four layers are a food-wax layer, a starch film layer, a thin polypropylene film layer, and a food-wax layer at sequence from inside to outside. A first air vent is provided penetrating the polypropylene film layer.

Further, a preparation method of the sealing film includes:

evenly punching 3-5 round holes on the thin polypropylene film layer;

coating starch film pulp on an inner surface of the thin polypropylene film layer; a temperature of the starch film pulp is maintained at 45-50° C.;

placing the coated thin polypropylene film in a vacuum drying oven, first drying the coated thin polypropylene film for 40 mins at 50° C., then drying the coated thin polypropylene film for 20 mins at 65° C. to form the starch film layer;

coating food wax respectively on an inner surface of the starch film layer and on an outer surface of the thin polypropylene film layer to form the food-wax layer and obtain a thin sheet; the food wax is made of a honeycomb;

drying and curing the thin sheet; and obtaining the sealing film.

Further, the protecting cap is a ¾ sphere cap. A crack is provided on the protecting cap, connected to the opening of the outlet part. The protecting cap is connected through with the opening of the outlet part to form a vent hole, after the protecting cap is threaded connected to the outlet part.

Further, the container main body is made from a round tubular material. One end of the container main body is sealed by hot melting and the other end of the container main body is in welded connection to the outlet part. A diameter of the container main body tapers from a portion near the outlet part to a portion away from the outlet part.

Further, the outlet part has a nipple shape.

Further, the opening of the outlet part has an oval shape.

Further, the food packaging container is configured to store a patient's diet, a convenient meal, infant food, military food.

Beneficial effects of the present disclosure include that the food packaging container, configured to store and heat food in microwave, has a simple structure and is convenient for storage. In addition, a placement condition has no need to be considered during the microwave heating and no fluid or heavy-paste diet will flow out from the food packaging container or the air venting holes are blocked.

A multi-layer sealing film is further provided, which has an excellent sealing property in natural environment and an unhindered air venting during microwave heating. The present disclosure meets food packaging safety requirements. The food packaging container in the present disclosure is widely used for preparing various kinds of food, exhibiting a promising future prospect.

### BRIEF DESCRIPTION OF DRAWINGS

In order to clearly demonstrate the technical solutions of the present disclosure, brief description is given of the drawings necessary in embodiments. Obviously, the drawings described below are only some of the embodiments of the present disclosure. For those ordinary skilled in art, some other drawings are obtained according to these drawings without creative labor.

FIG. 1 shows an exploded schematic view of the food packaging container of a first embodiment in the present disclosure.

FIG. 2 shows a schematic view of the food packaging container of the first embodiment in the present disclosure.

FIG. 3 shows a top schematic view of the food packaging container of the first embodiment in the present disclosure.

FIG. 4 shows a schematic view of the food packaging container of an embodiment in the present disclosure when the food packaging container is flatwise placed.

FIG. 5 shows a schematic view of the food packaging container of a second embodiment in the present disclosure.

FIG. 6 shows an exploded schematic view of the food packaging container of the second embodiment in the present disclosure.

FIG. 7 shows a schematic view of the food packaging container without the protecting cap of the second embodiment in the present disclosure.

FIG. 8 shows a schematic view of FIG. 7 without the sealing film.

FIG. 9 shows a schematic view of the protecting cap of the food packaging container of the second embodiment in the present disclosure.

FIG. 10 shows a top schematic view of the food packaging container without the protecting cap of a third embodiment in the present disclosure.

FIG. 11 shows a perspective view of an inverse-placed protecting cap of the food packaging container of the third embodiment in the present disclosure.

FIG. 12 shows an axial sectional view of the protecting cap of the food packaging container of the third embodiment in the present disclosure.

### DETAILED DESCRIPTION

Clear and complete description are given below of the technical solutions of embodiments, combined with the drawings of the embodiments in the present disclosure. Obviously, the embodiments are only a part but not all of the embodiments of the present disclosure. The detailed description of the embodiments of the disclosure is not intended to limit a protection scope of the disclosure, but merely to present selected embodiments of the disclosure. All other embodiments obtained by those skilled in the art based on the embodiments of the present disclosure without creative efforts shall fall within a protection scope of the present disclosure.

In the description below, it should be noted that terminology such as “inner”, “outer” and the like is based on the drawings to demonstrate an orientation or a location. The terminology is to facilitate the description of the present disclosure, but not to indicate or imply any specific direction or location relationship, orientation configuration or operation obligatory for a device or an element, which should not be understood as a limitation of the present disclosure. Terminology “first” “second” and the like are merely used to distinguish elements, which should not be understood as a primary and second relationship nor a limitation of the present disclosure.

Description is given below of the embodiments of the present disclosure in accordance with the drawings.

### Embodiment 1

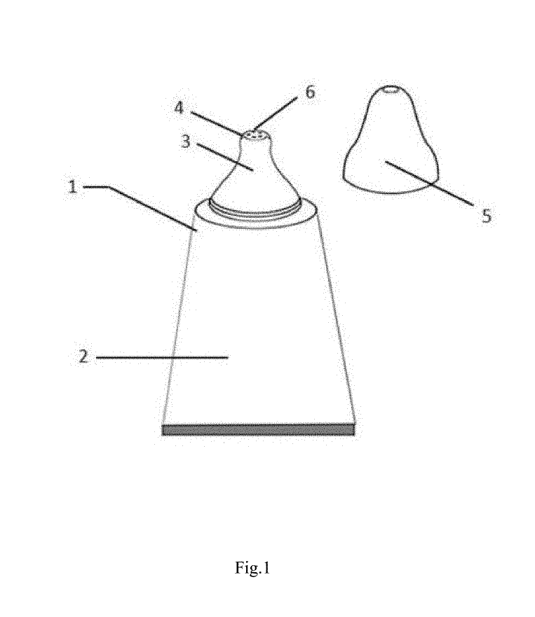

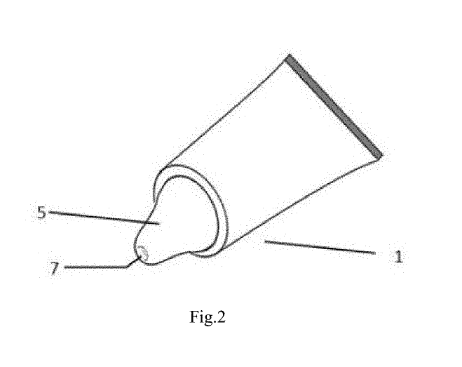

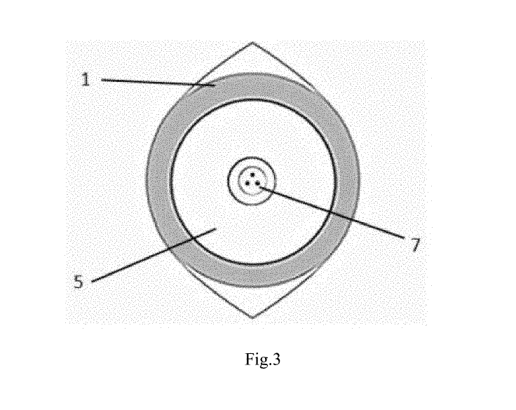

Combing with FIG. 1 to FIG. 4, the present disclosure provides an embodiment of the food packaging container for food storing and microwave heating. The food packaging container 1 comprises a container main body 2, an outlet part 3 connected to the container main body 2, and a protecting cap 5 sheathed on the outlet part 3, wherein an opening is provided on the outlet part 3. A sealing film 4 is provided on the opening. The container main body 2 is in threaded connection to the protecting cap 5. A globoidal bulge is provided on the protecting cap 5, which prevents an inverse placement. This design is to make sure that the food packaging container can not be inverse placed during a microwave heating and to prevent the food blocking air vent holes. The container main body 2 is cylindrical. The rear end of the container main body 2 is sealed by hot melting and the top end of the container main body is round, hot melted and welded to the outlet part 3. The top of the outlet part 3 is sealed by the sealing film 4. A plurality of first air vents 6 are provided on the sealing film 4. Preferably, a plurality of second air vents 7 coordinated with the first air vent 6 are provided on the protecting cap 5. A diameter range of a connecting section is 3-20 cm between the container main body 2 and the outlet part 3. Preferably, a diameter range of an opening end of the outlet part 3 is 0.7-10 cm. A diameter range is 0.5-6 cm of the end where the second air vent is provided on the protecting cap. Preferably, a diameter range of the first air vents is 0.5-2.0 mm, and a diameter range of the second air vents is 1.0-3.0 mm. Preferably, a number of the first air vents is 3-5, a number of the second air vents is 3. The second air vents are provided in a concave at 3-5 mm inside the top of the protecting cap.

The sealing film has the following functions: 1) air penetration during the microwave heating and 2) toleration to various natural environments of a sealing condition.

The sealing film has four layers. The four layers are respectively a food-wax layer, a starch film layer, a thin polypropylene film layer, and a food-wax layer from inside to outside. A first air vent is provided on the polypropylene film layer. The starch film layer is coated on an inner surface of the thin polypropylene film layer. The temperature of the starch film is maintained at about 45-50° C. The application of the starch film has two functions: 1) blocking the air venting hole on the thin film to seal the food packaging container; 2) melting automatically of the starch film layer on the venting holes during a microwave heating, and achieve air penetration.

The coated thin polypropylene film is placed in a vacuum drying oven, first the coated thin polypropylene film is dried for 40 mins at 50° C., then dried for 20 mins at 65° C., to form the starch film layer.

A preparation method of the starch film pulp is as follows:

1. mixing maize starch and crosslinked starch in a weight proportion of 4:1, dissolving the mixed starch in water to prepare a starch pulp of 25% wt;

2. adjusting the pH of the starch pulp to 5.0-6.0;

3. edible calcium chloride solution is added in a 1.5% wt of the starch pulp; a weight percentage concentration the calcium chloride solution is 3.6%; mixing and heating until 70° C.;

4. cooling rapidly from 70° C. to 45° C. after a complete gelatinization, and adding 50 μg of an isoamylase/g starch, mixing for 3 hours at a constant temperature of 45° C., then adding a same amount of isoamylase as before, mixing for another 6 hours.

Beneficial effects of the starch film layer are stated as follows.

Firstly, the composition is completely safe to the food. Even if the starch film layer is stained after heating and melting, the only composition strained is edible starch.

Secondly, the starch film layer has a high strength, a high tenancy, and an air proof. No air will penetrate to the container in a dry environment if the starch film layer is coated on the sealing film.

Thirdly, the starch film layer is melted when a temperature reaches 80° C. and a moisture reaches 55%. This characteristics enables an automatic melting of the starch film layer coated on the sealing film of the food packaging container during a microwave heating when the temperature reaches over 80° C. Air is vented through the air venting holes on the sealing film, so as to avoid an explosion induced by an accumulation of water steam in the package container.

Food wax is used both on the innermost layer and the outermost layer of the sealing film 4. The food wax is made of honey comb, which is safe to human health. The function of the food wax layer to prevent moisture, since the starch film layer is melted when the moisture content reaches 55%. Food wax is therefore coated on the innermost layer and the outermost layer of the sealing film to avoid a condition of starch film invalidation and air leakage, when a moisture content of the environment is over-high during a transportation and storage process, or when a moisture content of food itself is over-high. The food wax layer is melted with the starch film layer during microwave heating, allowing air venting through the air venting holes.

The sealing film with the previously mentioned characteristics has excellent mechanical moistureproof properties, ensuring food in the packaging container from being damaged and dampened. Food-grade raw materials are used of starch film layer and the food wax layer, which is configured to be melted rapidly after microwave heating and provides both food safety and smooth air venting.

When the food packaging container is used for storage but not for microwave heating (for example packing black sesame paste, sweetened bean paste and stuffing for dumplings and the like), no second air vent holes 7 are necessary. When the food packaging container needs to be microwave heated (for example for porridge, paste, instant food, vegetable mesh, or meat mesh and the like), the second air vents are configured to be provided at the concave on the top of the protecting cap. The second air vents 7 are coordinated with the first air vents 6. The second air vents are provided with a paraffin sealing layer, preventing moisture and dust from the environment. The concave structure is configured to protect the paraffin sealing layer.

As shown in figures continually, the paste food is sealed by the container main body 1, and the opening of the container main body 1 is covered with the sealing film 4. The protecting cap is in threaded connection on the container main body 1 to avoid the damage of the sealing film 4. The specific structure of the food packaging container decides the opening faces diagonally upwards always no matter the form of the packaging container placed. This configuration ensures the food in the container not to be flew out from the container or block the opening. The food-wax layer and the starch film layer on the sealing film 4 and the paraffin layer on the protecting cap 5 will be melted during a microwave heating when the temperature reaches over 80° C., so that air is vented through the air vent holes smoothly.

To reduce residual space of the food packaging container for more food, an upward inclined angle of the opening of the outlet part 3 is increased. Increasing the diameter of the food packaging container will significantly promote the upward inclined angle of the opening of the outlet part. However, users may feel uncomfortable if the diameter is over large, and appearance of the packaging container is also negatively affected. A configuration has three purposes that the diameter of the opening of the outlet part decrease gradually from upward to downward (upward is defined as a direction being away from the container main body, and downward is defined as a direction being close to the container main body). Firstly, it provides comfort for the lips and mouth contacting the opening. Secondly, the opening is not going too far in the mouth to burn the user. Thirdly, an inclined slope is provided at an inner layer of the packaging container, enabling the food to be difficult to flow to the opening and to block the air vents.

Packaging the paste food by the food packaging container according to the following steps.

Step 1: sterilizing the food physically. The physical sterilization includes ultrasonic sterilization. Fluorescent bacteria, escherichia coli bacteria and bacteria such as salmonella typhi are died out through ultrasonic process.

Step 2: placing the sterilized food in the food packaging container. The amount of food to be placed, is not subject to flow out of the outlet part of the food packaging container.

Step 3: vacuum treatment on the food packaging container to remove air of the food packaging container, and introducing relatively inert mixed gas at 1 atm. The mixed gas is N₂ and CO₂.

Step 4: sealing the air outlet by the sealing film 4 and screwing the protecting cap 5 to obtain a product.

When the above product is served, the packaging container is taken out after microwave heating. the protective cap 5 and the sealing film 4 are removed, and pressure is applied to the container main body 1 to extrude the food from the packaging container, that is, the food heated is opened and ready to serve. The food packaging container can be applied in preparing wartime food, picnic food, convenient meal, fast food, porridge paste, military food and the like.

As an embodiment of the air ventilation structure for air exhaust, air ventilation holes are formed by connecting the outlet part and the protecting cap, and connecting the crack and the opening of the outlet part, coordinated with the air outlet. Food can always be below the horizontal level of the air outlet during microwave heating by appearance characteristics of the food packaging container. The sealing film can automatically be unsealed and form the air outlet when pressure inside the package increases.

### Embodiment 2

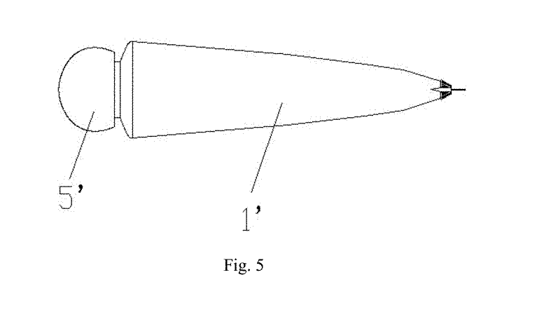

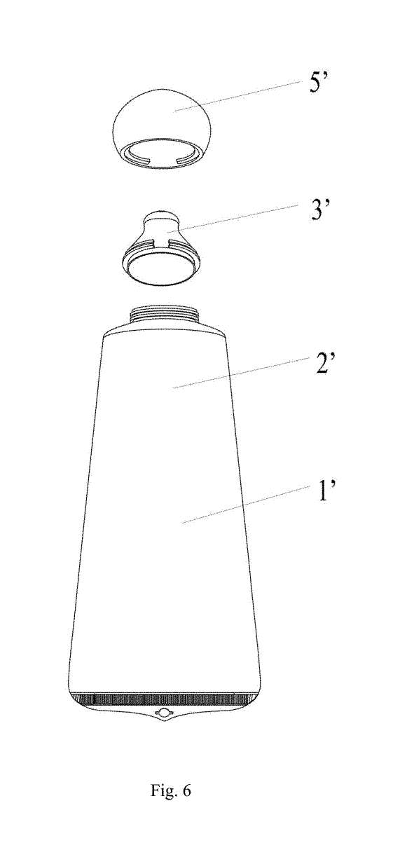

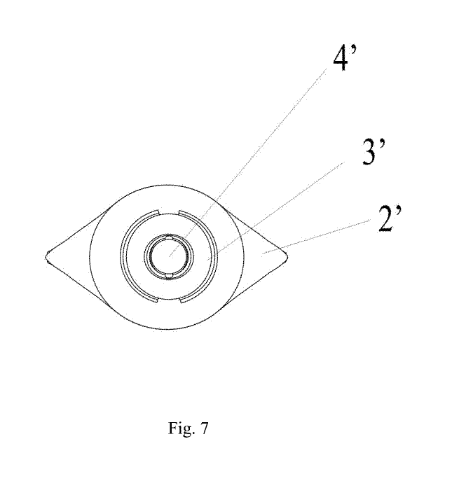

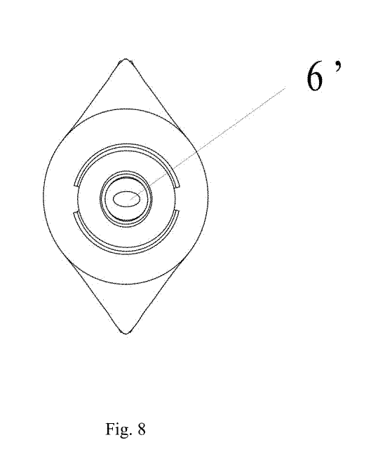

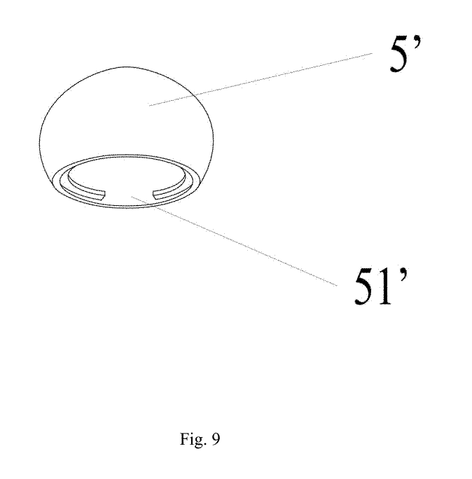

Combing with FIG. 5 to FIG. 9, the present disclosure provides a second embodiment of the food packaging container for food storing and microwave heating. The protecting cap 5′ is a cap with a ¾ sphere shape. The outlet part 3′ is in threaded connection to the protecting cap 5′. A crack 51′ is provided on the protecting cap 5′ connected to the opening of the outlet part 3′. The crack 51′ is connected to the opening of the outlet part 3′ to form a vent hole, after the protecting cap 5′ is in threaded connection to the outlet part. The container main body 2′ is made from a round tubular material. The rear end of the container main body 2′ is sealed by hot melting and the top end of the container main body 2′ is hot melted and welded to the outlet part 3′. The inner top end is 3 mm away from the sealing film of the protecting cap 5′. The internal of the protecting cap is smooth with a large inner space. The crack 51′ is provided at each of two ends of the thread buckle. The crack 51′ is configured to just coincide with a crack on the thread buckle of the outlet part 3′, under the condition that the protecting cap 5′ screws the food packaging container tightly, to form an air outlet tunnel. The functions are: firstly, the packaging container cannot be inverse placed due to its sphere shape. Only flatwise placement is possible in the microwave, of which the outlet faces diagonally upwards. If the packaging container can be inversely placed like the cosmetics, the outlet will be blocked. Explosion is possible if the food is overheated by microwaves. Secondly, the protecting cap has a relatively large and smooth bore, with a preserved air outlet tunnel at two sides of the thread mouth. If the food is overheated by microwaves and the air burst out of the sealing film 4′, the air impulsion is reduced by the protecting cap, flowing smoothly out from the air outlet tunnel.

The diameter of the container main body 2′ is gradually decreased along an opposite direction to the outlet part 3′. The end has a flat shape of the container main body 2′ away from the outlet part 3′. Preferably, the container main body 2′ has an “A” shape when placing flatwise. By setting the A-shaped container, the outlet always faces obliquely upward when the container is laid flat. In a case of a thick paste-like food, the food does not block the outlet completely when the package is not full, imposing a significant function for smooth air venting. The outlet part 3′ has a nipple shape and is made of hard plastic. The nipple-shaped outlet part is convenient for users to contain in the mouth or to suck. The thick paste-like food is convenient to enter the user's mouth without great effort by pressing an lower part of the container main body and sucking. Another way of eating is possible for the configuration of the separate outlet. When the nipple-shaped outlet part is unscrewed, the package container outlet becomes a wide cup and you can drink the food into your mouth just like drinking water. The outlet part 3′ has an oval shape. The sealing film 4′ is sealed to open the opening of the outlet part 3′ by hot pressing. The long axis of the oval is perpendicular to the flat rear of the container main body. That is, the oblong opening is placed with its long axis along the vertical direction, when the packaging is placed flatwise.

The packaging container has a simple structure for food storing and microwave heating and is easy to be stored. The configuration of the packaging container ensures that the outlet of the packaging container is diagonally upward without any consideration of the placement during microwave heating, so that the thick paste-like food will not flow out of the container or block the air ventilation holes. The sealing film is a multi-layer structure, which has excellent sealing moisture-proof property in the natural environment. It can smoothly exhaust air when heated by microwave and meets the requirements of food safety standards.

As another embodiment of the air ventilation structure for air exhaust, air outlet tunnel is formed by connecting through between the outlet part and the space between the protecting cap and the container main body, and through the coincidence of the crack 51′ on the protecting cap and the crack on the outlet part, coordinated with the air outlet. Food can always be below the horizontal level of the air outlet during microwave heating by appearance characteristics of the food packaging container. The sealing film can automatically be unsealed and form the air outlet when pressure inside the package increases.

### Embodiment 3

In order to make the present disclosure more clearly, a complete and detailed description is given as follows of a third embodiment.

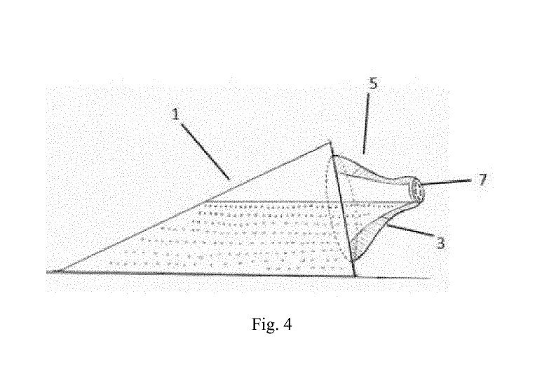

The packaging container main body is further configured as follows, based on the previous embodiments. The appearance of the container main body is: a cross-section of the container main body adjacent to the outlet part is similar to round. The cross-section of the container main body gradually flattens to the rear end of the container main body. For example, for a part of the container main body which is adjacent to the outlet part, the cross-section thereof is round, while the cross-section is a flattened rectangular of a part adjacent to the rear end of the container main body. A shape is formed similar to a tooth-paste by the transition from round to flattened rectangular. From a lateral view of the food packaging container, it is appeared as a rectangular shape with an elevated outlet part (as shown in FIG. 4). The appearance can also be an embodiment similar to a hook surface of a cone and a rear end of the container main body is provided at a constricted end of the generally conical hook surface. For example, the cross section has a big round shape of the main body adjacent to the outlet part, and has a small round shape of rear end of the main body. An apex of the rear end is reduced to a point, forming a cone. A shape of an elevated triangle is present from a lateral view of the food packaging container. The top of the protecting cap is preferably an outward bumped, rounded convex surface. The shape of the container main body and the protecting cap can be coordinated with each other. The food stored in the packaging container is preferably fluid food. The opening of the outlet part is always inclined upward so that the level of the liquid food is always below the level of the air outlet formed by unsealing of the opening of the outlet part, when the food packaging container is arbitrarily placed and heated, for example, placed in a microwave oven. This structure not only helps to increase volume of the stored food, but also helps to ensure a smooth exhaust through the air outlet, which is particularly beneficial to the microwave heating. The heating operation is simple, convenient and safe, especially for safety of the elderly and children or those not familiar with microwave operating knowledge.

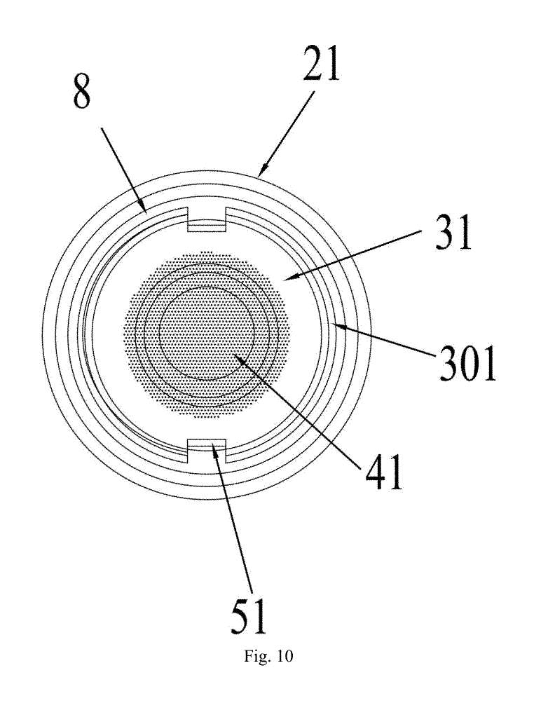

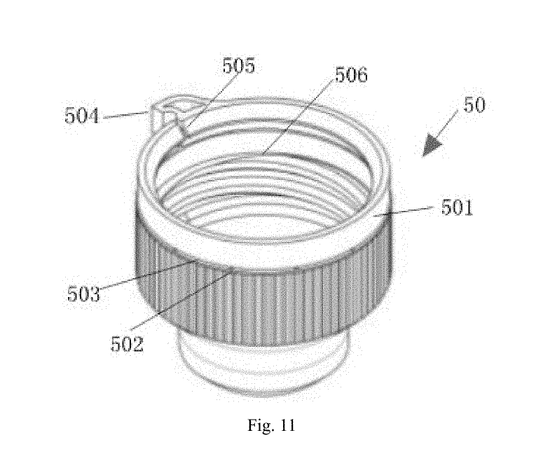

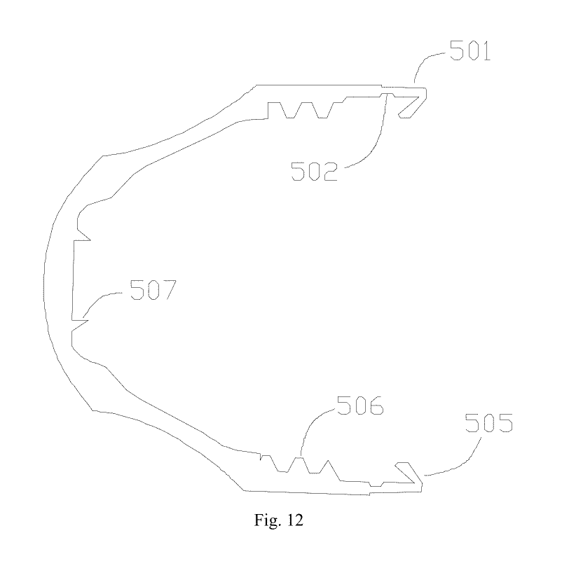

The container main body described above is suitable for this embodiment, as shown in FIG. 10 to FIG. 12. The food packaging container includes a container main body 21, an outlet part 31 connected to the container main body 21, a protecting cap 50 sheathed on the outlet part 31. An opening is provided on the outlet part 31 and a sealing film 41 is provided on the opening. The container main body is implemented in a conical way. The outlet part 31 and the container main body 21 are preferably one integrated structure.

The sealing film comprises preferably 3 layers, which are respectively a polypropylene layer with fine wrinkles, an aluminum foil layer with fine wrinkles, a polypropylene layer without wrinkles from inside to outside. Polypropylene is preferably used as a material of the opening of the outlet part 31. The sealing film is hot melted on the opening through the polypropylene layer with fine wrinkles.

The function of the polypropylene layer with fine wrinkles are hot welded to the outlet mouth made of polypropylene, which can adhere and seal the outlet mouth and also can separate easily with the adhered outlet mouth when necessary. Polypropylene is safely contactable with food. The aluminium foil layer is able to increase a blocking coefficient of the material, but also increase facility of striping the layers. The polypropylene layer without wrinkles is to tolerate a high temperature during sterilization and to cover the aluminum foil, preventing a direct contact between the food and the aluminum foil during microwave heating.

The sealing film with this structure, on one hand satisfy safety standard for food transportation and storing. The sealing effect is excellent with a high blocking efficiency. Moisture and air are both blocked and food can be stored at normal temperature. It is easy to unseal the film even if the food is not heated. On the other hand, the sealing film will be unsealed automatically to form the air outlet, since the edge of the sealing film is endured by an integrated function of an expansion pressure and will get rid of the adhesion at the opening. Smooth air exhaust is achieved with its simple structure, convenient production and high reliability.

An inner circumferential surface of the protecting cap 50 comprises inner thread 506. An outer circumferential surface comprises outer thread 301 of the outlet part 31, adjacent to the container main body. The protecting cap 50 and the container main body 21 are in threaded connection to the inner thread 506 and the outer thread 301. A cavity for connecting the air outlet and an air vent groove 51 is formed between the protecting cap 50 and the outlet part 31. The air vent groove 51 is provided on the inner circumferential surface or the outer circumferential surface to connect the cavity and the environment and to exhaust air in the detailed embodiment.

Specifically, as shown in FIG. 10, the outer thread 301 at the outlet part is not consistent but is separated by two vertical air vent grooves. In the detailed embodiment, a number of the air vent grooves is preferably 2. The air vent groove of this configuration is able to ensure a smooth air exhaust no matter if the protecting cap is fastened or not, compared to the end structure of embodiment 2. When specifically used, air tunnel is left in the air vent groove, releasing hot air along a lower edge of the protecting cap from the sealing film if the food is heated. This configuration improves safety of the food packaging container.

The present disclosure further includes a limiting edge 501. A connecting rib 502 is provided as a downward extension of the bottom of the protecting cap 50 to connect the limiting edge 501. The outer circumferential surface further includes a limiting ring-shape convex 8. The limiting edge 501 coordinates with the limiting ring-shape convex 8, to prevent screwing of the protection cap 50 and to form the cavity. A gap 503 between two adjacent connecting ribs 502 connects between the air vent groove 51 and the environment, so that a smooth and reliable air exhaust is performed. On this basis, the limiting edge 501 is preferably configured to be striped off, so that the protecting cap 50 is configured to be further screwed to protect a second sealing of the opening of the outlet part 31 at the inner top of the protecting cap 50. This configuration will seal unfinished food for a second time for further serving, which is beneficial for food storage, preservation and hygiene.

In the detailed embodiment, the inner top of the protecting cap 50 is configured to be 4 mm higher than the opening of the outlet part 31 when closed tightly. This configuration is to enable the sealing film 41 to release air after being unsealed and to leave some space for the unsealing of the sealing film. Also, space is preserved for further screwing and covering the opening of the outlet part for the second sealing. The gap 503 between the limiting edge 501 and the protecting cap 50 is wider compared to that of existing normal bottle caps. The height of the gap is about 1 mm, and height of the limiting edge is about 5 mm. This configuration is firstly to release hot air exhausted from the sealing film passing through the cavity and air vent groove 51. Secondly the protecting cap 50 can be further screwed for 4 mm when the limiting edge 501 is stripped off, so that a second sealing is achieved by closing attaching to adjacent surface around the opening of the outlet part of the inner top of the protecting cap 50. Specifically, the inner top of the protecting cap 50 is preferably a circular bump 507. When the protecting cap is fastened tightly, an inverse boil-shape structure is formed by the circular bump 507 together with the protecting cap 50, achieving a second sealing coordinated with the opening of the outlet part. This configuration has better sealing effect and is more reliable.

A buckle 504 is provided at one end of the limiting edge 501 on the outside extending outwards, which is convenient to stripping off the limiting edge. An end of the limiting edge 501 on the inside has roughly a “V” shape structure 505. The “V” shape structure 505 coordinates with the outer circumferential surface, so that an angle formed by the “V” shape structure 505 increases when the protecting cap 50 is screwed and decrease when the protecting cap 50 is unscrewed. This configuration is to adjust friction force and prevent from retreating of the protecting cap, so that the protecting cap 50 caps tightly on the outlet part 31 without automatic retreat, unless the protecting cap is unscrewed, which has better protection effect, so that the limiting edge 501 with this structure is also called anti-inverted ring.

When the food packaging container is used of the present disclosure, people with any knowledgeable level can freely place it in a microwave oven for direct heating without regard to its placement form and heating time (the heating time is only related to temperature of the food), such as whether it is opened, whether it is inverted, or whether the heating time is too long. The food packaging container of the disclosure is conducive to preservation of food at normal temperature, which is convenient for carrying and instant cooking after opening. When being heated in a microwave, the food packaging container can be placed arbitrarily, heated directly. The sealing film can be unsealed automatically and air can be exhausted easily without any food explosion. By the second sealing configuration, it is beneficial for food hygiene and conservation with high reliability, high security and simple structure.

It should be noted that various parts of the drawings are not drawn according to their relative sizes of the present disclosure. Some dimensions have been exaggerated compared with other related standards for clear description and easy understanding, and the related details are not completely drawn, in order to simplify the figure.

The above is the preferred embodiment of the present disclosure. It should be noted that those skilled in the art may make some improvements and modifications without departing from the principle of the present disclosure, which should still fall in the protection scope of the present disclosure.

What is claimed is:

1. A food packaging container for storing food to be heated in microwave, comprising:
a container main body,
an outlet part connected through to the container main body, and
a protecting cap sheathed on the outlet part;
wherein an opening is provided on the outlet part;
a sealing film is provided on the opening; the sealing film is configured to automatically unseal the opening to form an air outlet;
an air ventilation structure is further provided coordinated with the air outlet for air exhaust between the outlet part and the protecting cap, and/or between the outlet part, the protecting cap and the container main body; and
food is stored below a horizontal level of the outlet part when the food stored in the food packaging container is heated.

2. The food packaging container according to claim 1, wherein
the container main body is screwed with the protecting cap; and
a globoidal bulge is provided on a top of the protecting cap.

3. The food packaging container according to claim 1, wherein
the sealing film has four layers;
the four layers are a food-wax layer, a starch film layer, a thin polypropylene film layer, and a food-wax layer at sequence from inside to outside; and
the polypropylene film layer is provided with a plurality of first air vents.

4. The food packaging container according to claim 1, wherein
a plurality of secondary air vents are provided coordinated with the first air vent on the protecting cap.

5. The food packaging container according to claim 4, wherein
a diameter of the first air vent is in a range of 0.5-2.0 mm; and
a diameter of the second air vents is in a range of 1.0-3.0 mm.

6. The food packaging container according to claim 5, wherein
a number of the first air vent is 3-5;
a number of the second air vents is 3; and
the second air vents are provided in a concave at 3-5 mm inside the top of the protecting cap.

7. The food packaging container according to claim 3, wherein a preparation method of the sealing film comprising:
evenly punching 3-5 round holes on the thin polypropylene film layer;
coating starch film pulp on an inner surface of the thin polypropylene film layer; a temperature of the starch film pulp is maintained at 45-50° C.;
placing the coated thin polypropylene film in a vacuum drying oven, first drying the coated thin polypropylene film for 40 mins at 50° C., then drying the coated thin polypropylene film for 20 mins at 65° C. to form the starch film layer;
coating food wax respectively on an inner surface of the starch film layer and on an outer surface of the thin polypropylene film layer to form the food-wax layer and obtain a thin sheet; the food wax is made of a honeycomb;
drying and curing the thin sheet; and
obtaining the sealing film.

8. The food packaging container according to claim 1, wherein
the protecting cap is a ¾ sphere cap;
a crack is provided on the protecting cap, connected through to the opening of the outlet part; and
the protecting cap is connected through with the opening of the outlet part to form a vent hole after the protecting cap is screwed with the outlet part.

9. The food packaging container according to claim 8, wherein
the container main body is made from a round tubular material;
one end of the container main body is sealed by hot melting and the other end of the container main body is in welded connection to the outlet part; and
a diameter of the container main body tapers from a portion near the outlet part to a portion away from the outlet part.

10. The food packaging container according to claim 9, wherein the outlet part has a nipple shape.

11. The food packaging container according to claim 10, wherein the opening of the outlet part has an oval shape.

12. The food packaging container according to claim 1, wherein a cross-section of the container main body adjacent to the outlet part has a substantially round shape; and
the substantially round shape of the cross-section of the container has been gradually flatten until a rear end of the container main body.

13. The food packaging container according to claim 1, wherein an outer surface of the container main body is a substantially conic surface; and
the rear end of the container main body is at a serrated end of the roughly conic surface.

14. The food packaging container according to claim 1, wherein the sealing film comprises a polypropylene layer with fine wrinkles, an aluminum foil layer with fine wrinkles, a polypropylene layer without wrinkles at sequence from inside to outside;
polypropylene is used as a material of the opening; and
the sealing film is hot melted on the opening through the polypropylene layer with fine wrinkles.

15. The food packaging container according to claim 1, wherein
an inner circumferential surface comprises inner threads of the protecting cap;
an outer circumferential surface comprises outer threads of the container main body part adjacent to the outlet part;
the protecting cap and the container main body are screwed together through the inner threads and the outer threads;
a cavity is formed between the protecting cap and the outlet part, for connecting through the outlet part and an air vent groove; and
the air vent groove is provided on the inner circumferential surface and/or the outer circumferential surface to connect the cavity and the environment.

16. The food packaging container according to claim 15, wherein
the food packaging container further comprises a limiting edge;
the bottom end of the protecting cap is circumferentially downward extended at intervals to form a connecting rib to connect the limiting edge;
the outer circumferential surface further comprises a limiting ring-shape convex;
the limiting edge coordinates with the limiting ring-shape convex to prevent screwing of the protection cap and to form the cavity; and
a gap between two adjacent connecting ribs connects the air vent groove and the environment.

17. The food packaging container according to claim 16, wherein
the limiting edge is configured to be striped off, so that the protecting cap is configured to be further screwed, and the opening is sealed by an inner top of the protecting cap.

18. The food packaging container according to claim 16, wherein a raised buckle is provided at one end of the limiting edge on the outside extending outwards.

19. The food packaging container according to claim 16, wherein
the limiting edge on the inside has roughly a “V” shape structure; and
the “V” shape structure coordinates with the outer circumferential surface, so that an angle formed by the “V” shape structure is increased when the protecting cap is screwed and the angle is decreased when the protecting cap is unscrewed.

20. An application of the food packaging container according to claim 1, characterized in that the food packaging container is configured to store a patient's diet, a convenient meal, infant food and military food.
